(19) United States
(12) Patent Application Publication
(10) Pub. No.: US 2016/0049122 A1
(43) Pub. Date: Feb. 18, 2016

(54) DISPLAY APPARATUS AND METHOD OF DRIVING THE SAME

(71) Applicant: Samsung Display Co., Ltd., Yongin-City (KR)

(72) Inventors: Seon-Tae Yoon, Seoul (KR); Kwang-Keun Lee, Osan-si (KR); Jung-Hyun Kwon, Seoul (KR); Hae-Il Park, Seoul (KR)

(21) Appl. No.: 14/601,705

(22) Filed: Jan. 21, 2015

(30) Foreign Application Priority Data
Aug. 14, 2014 (KR) 10-2014-0106183

(51) Int. Cl. G09G 3/36

(52) U.S. Cl. CPC G09G 3/3607; G09G 2300/0452; G09G 2300/0842; G09G 2310/08

(57) ABSTRACT

A display apparatus includes a display panel, a display panel driver, a light source part and a local dimming driver. The display panel includes a first subpixel having a first primary color, a second subpixel having a second primary color and a transparent subpixel. The display panel driver is configured to set grayscales of the first subpixel, the second subpixel and the transparent subpixel. The light source part includes a plurality of light emitting blocks configured to provide light to the display panel. The light emitting block includes a first light source configured to generate a light of a mixed color and a second light source configured to generate a light of a third primary color. The local dimming driver is configured to alternately turn on and off the first light source and the second light source and configured to independently drive the light emitting blocks.

### CLAIM OF PRIORITY

This application claims priority under 35 U.S.C. §119 to Korean Patent Application No. 10-2014-0106183, filed on Aug. 14, 2014 in the Korean Intellectual Property Office KIPO, the contents of which are herein incorporated by reference in their entireties.

### BACKGROUND OF THE INVENTION

1. Field of the Invention

Exemplary embodiments of the present invention relate to a display apparatus and a method of driving the display apparatus. More particularly, exemplary embodiments of the present invention relate to a display apparatus improving a display quality and a method of driving the display apparatus.

2. Description of the Related Art

Generally, a liquid crystal display (“LCD”) apparatus displays a multi-color image or full-color image in a spatial color display mode. In the spatial color display mode, white light emitted by a back-light unit passes through three color-filters which are spatially divided to generate a color light.

In the spatial color display mode, a unit pixel includes three color subpixels having the three color-filters so that the LCD apparatus of the spatial color display mode substantially has a resolution decreased to be about ⅓ of the total number of the subpixels. In the spatial color display mode, optical loss may occur due to absorption or reflection by the color-filters.

In a field sequential driving method, the back-light unit includes a light source part which provides light to a display panel. The light source part includes a red light emitting part emitting a red light, a green light emitting part emitting a green light and a blue light emitting part emitting a blue light, that are sequentially turned on.

The field sequential driving method needs to change colors rapidly. The field sequential driving method has a defect such as a color breakup. The color breakup may occur in an edge of an object when a speed of color switching is relatively slow.

### SUMMARY OF THE INVENTION

Exemplary embodiments of the present invention provide a display apparatus capable of improving a display quality.

Exemplary embodiments of the present invention also provide a method of driving the display apparatus.

According to an exemplary embodiment, a display apparatus includes a display panel, a display panel driver, a light source part and a local dimming driver. The display panel includes a first subpixel having a first primary color, a second subpixel having a second primary color and a transparent subpixel. The display panel driver is configured to set grayscales of the first subpixel, the second subpixel and the transparent subpixel. The light source part includes a plurality of light emitting blocks configured to provide light to the display panel. The light emitting block includes a first light source configured to generate a light of a mixed color and a second light source configured to generate a light of a third primary color. The local dimming driver is configured to alternately turn on and off the first light source and the second light source and configured to independently drive the light emitting blocks.

In an exemplary embodiment, the local dimming driver may be configured to determine first dimming levels of the first light sources as block_max(A, B, C) during a first subframe when the first light sources are turned on and to determine second dimming levels of the second light sources as block_max(C) during a second subframe when the second light sources are turned on. A grayscale of the first primary color is A. A grayscale of the second primary color is B. A grayscale of the third primary color is C. A maximum grayscale of A, B and C in an image block corresponding to the light emitting block is block_max(A, B, C). A maximum grayscale of C in the image block is block_max(C).

In an exemplary embodiment, the display panel driver may be configured to set the grayscale of the first subpixel to A-min(A, B, C), the grayscale of the second subpixel to B-min(A, B, C) and the grayscale of the transparent subpixel to min(A, B, C) during the first subframe. The display panel driver may be configured to set the grayscale of the transparent subpixel to C-min(A, B, C) during the second subframe. min(A, B, C) is a minimum grayscale of A, B and C.

In an exemplary embodiment, the mixed color may be white. The third primary color may be blue.

In an exemplary embodiment, the display panel driver may be configured to set the grayscale of the first subpixel to A-min(A, B), the grayscale of the second subpixel to B-min(A, B) and the grayscale of the transparent subpixel to min(A, B) during the first subframe. The display panel driver may be configured to set the grayscale of the transparent subpixel to C during the second subframe. min(A, B) is a minimum grayscale of A and B.

In an exemplary embodiment, the mixed color may be yellow. The third primary color may be blue.

In an exemplary embodiment, the mixed color may be magenta. The third primary color may be green.

In an exemplary embodiment, the mixed color may be cyan. The third primary color may be red.

In an exemplary embodiment, the display panel driver may be synchronized with the local dimming driver.

In an exemplary embodiment, the first primary color may be red. The second primary color may be green.

According to an exemplary embodiment, a method of driving a display apparatus includes setting grayscales of a first subpixel having a first primary color, a second subpixel having a second primary color and a transparent subpixel, determining a plurality of first dimming levels and a plurality of second dimming levels of a plurality of light emitting blocks, turning on the light emitting blocks based on the first dimming levels during a first subframe and turning on the light emitting blocks based on the second dimming levels during a second subframe.

In an exemplary embodiment, the first dimming level may be determined as block_max(A, B, C) and the second dimming level is determined as block_max(C). A grayscale of the first primary color is A. A grayscale of the second primary color is B. A grayscale of the third primary color is C. A maximum grayscale of A, B and C in an image block corresponding to the light emitting block is block_max(A, B, C). A maximum grayscale of C in the image block is block_max(C).

In an exemplary embodiment, the grayscale of the first subpixel may be set to A-min(A, B, C). The grayscale of the second subpixel may be set to B-min(A, B, C). The grayscale of the transparent subpixel may be set to min(A, B, C) during the first subframe. The grayscale of the transparent subpixel may be set to C-min(A, B, C) during the second subframe. min(A, B, C) is a minimum grayscale of A, B and C.

In an exemplary embodiment, the mixed color may be white. The third primary color may be blue.

In an exemplary embodiment, the grayscale of the first subpixel may be set to A-min(A, B). The grayscale of the second subpixel may be set to B-min(A, B). The grayscale of the transparent subpixel may be set to min(A, B) during the first subframe. The grayscale of the transparent subpixel may be set to C during the second subframe. min(A, B) is a minimum grayscale of A and B.

In an exemplary embodiment, the first light source may be configured to generate a yellow light. The second light may be configured to generate a blue light.

In an exemplary embodiment, the first light source may be configured to generate a magenta light. The second light may be configured to generate a green light.

In an exemplary embodiment, the first light source may be configured to generate a cyan light. The second light may be configured to generate a red light.

According to exemplary embodiments of the display apparatus and the method of driving the display apparatus, the light sources having different colors are alternately turned on with a local dimming method so that a display quality of the display panel may be improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating a display apparatus according to an exemplary embodiment of the inventive concept;

FIG. 2 is a plan view schematically illustrating a display panel and a light source part of FIG. 1;

FIG. 3 is a cross-sectional view illustrating the display panel and the light source part of FIG. 1;

FIG. 4A is a cross-sectional view illustrating the display panel and the light source part of FIG. 1 in a first subframe;

FIG. 4B is a cross-sectional view illustrating the display panel and the light source part of FIG. 1 in a second subframe;

FIG. 5 is a cross-sectional view illustrating a display panel and a light source part according to an exemplary embodiment of the inventive concept;

FIG. 6A is a cross-sectional view illustrating the display panel and the light source part of FIG. 5 in a first subframe;

FIG. 6B is a cross-sectional view illustrating the display panel and the light source part of FIG. 5 in a second subframe;

FIG. 7 is a cross-sectional view illustrating a display panel and a light source part according to an exemplary embodiment of the inventive concept; and

FIG. 8 is a cross-sectional view illustrating a display panel and a light source part according to an exemplary embodiment of the inventive concept.

### DETAILED DESCRIPTION OF THE INVENTION

Hereinafter, the present invention will be explained in detail with reference to the accompanying drawings.

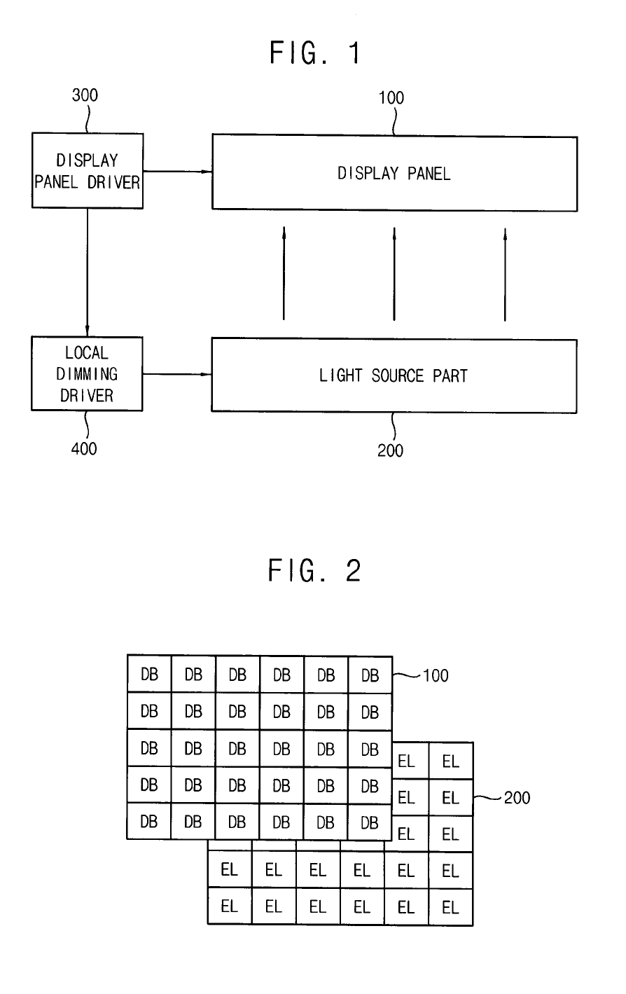

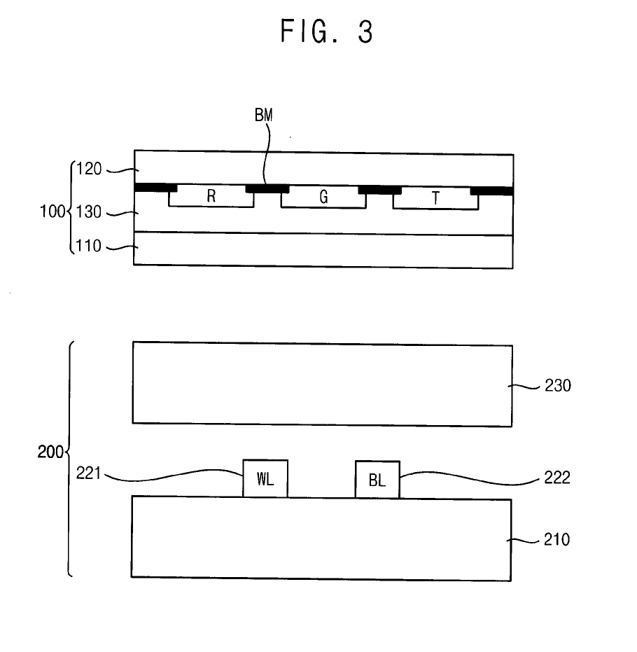

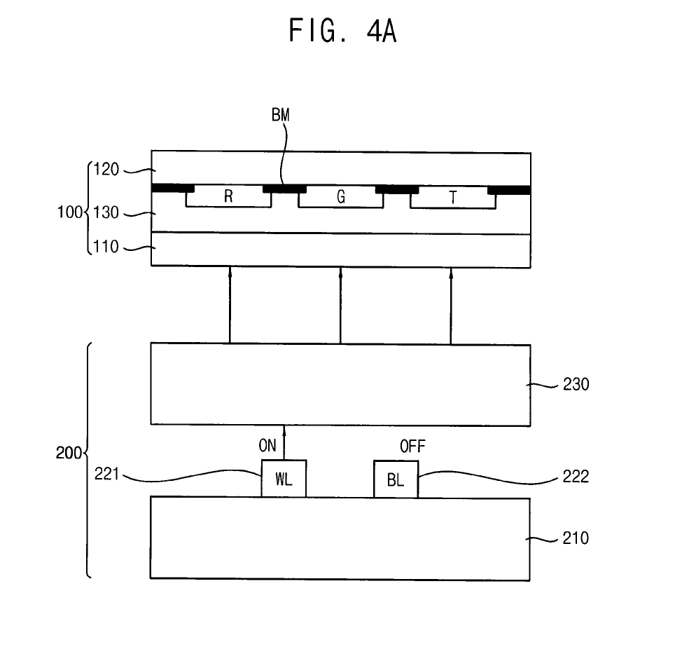

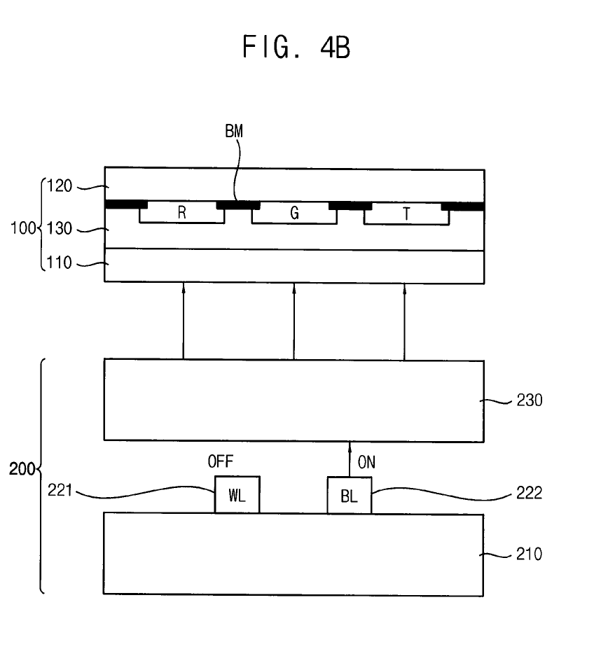

FIG. 1 is a block diagram illustrating a display apparatus according to an exemplary embodiment of the present invention. FIG. 2 is a plan view schematically illustrating a display panel and a light source part of FIG. 1. FIG. 3 is a cross-sectional view illustrating the display panel and the light source part of FIG. 1. FIG. 4A is a cross-sectional view illustrating the display panel and the light source part of FIG. 1 in a first subframe. FIG. 4B is a cross-sectional view illustrating the display panel and the light source part of FIG. 1 in a second subframe.

Referring to FIGS. 1 to 4B, the display apparatus includes a display panel 100, a light source part 200, a display panel driver 300 and a local dimming driver 400.

The display panel 100 displays an image. The display panel 100 includes a plurality of unit pixels, a first substrate 110, a second substrate 120 and a liquid crystal layer 130. The number of the unit pixels are M*N. Herein M and N are positive integers. The display panel 100 may include a plurality of display blocks DB. The display block includes at least one unit pixel. For example, the number of the display blocks DB is m*n. Herein m and n are positive integers. Herein, m<M and n<N.

The unit pixel includes a first subpixel R having a first primary color, a second subpixel G having a second primary color and a transparent subpixel T.

In the present exemplary embodiment, the first primary color is red. The first subpixel R is a red subpixel. The second primary color is green. The second subpixel G is a green subpixel.

The first substrate 110 may be a thin film transistor (“TFT”) substrate including a plurality of TFTs. The first substrate 110 may further include a plurality of gate lines extending in a first direction and a plurality of data lines extending in a second direction crossing the first direction. The first substrate 110 may further include a pixel electrode. For example, each of the first subpixel R, the second subpixel G and the transparent subpixel T includes a switching element which is connected to the gate line and the data line and a liquid crystal capacitor and a storage capacitor which are connected to the switching element.

The second substrate 120 faces the first substrate 110. The second substrate 120 may be a color filter substrate including a plurality of color filters. The second substrate may further include a common electrode.

The first subpixel R may be defined by a red color filter disposed on the second substrate 120. The second subpixel G may be defined by a green color filter disposed on the second substrate 120. The transparent subpixel T may be defined by a transparent color filter disposed on the second substrate 120. For example, the transparent color filter may be a substantially empty space at which any color filter is not disposed. A light blocking pattern BM may be disposed between the color filters.

The liquid crystal layer 130 is disposed between the first and second substrates 110 and 120.

Although the color filters are disposed on the second substrate 120 in the present exemplary embodiment, the present invention is not limited thereto.

The display panel driver 300 is connected to the display panel 100 to drive the display panel 100. The display panel driver 300 may include a timing controller, a gate driver and a data driver.

The timing controller receives input image data and an input control signal. The input image data may include red image data, green image data and blue image data. The input control signal may include a master clock signal and a data enable signal. The input control signal may further include a vertical synchronizing signal and a horizontal synchronizing signal.

The timing controller generates a first control signal, a second control signal and a third control signal based on the input image data and the input control signal. The timing controller outputs the first control signal to control a driving timing of the gate driver to the gate driver. The timing controller outputs the second control signal to control a driving timing of the data driver to the data driver. The gate driver outputs a gate signal to the gate lines of the display panel 100. The data driver outputs a data signal to the data lines of the display panel 100.

The display panel driver 300 sets grayscale data of the first, second and transparent subpixels R, G and T.

The display panel driver 300 outputs the input image data and the third control signal to control a driving timing of the local dimming driver 400 to the local dimming driver 400. The display panel driver 300 may be synchronized with the local dimming driver 400.

The light source part 200 includes a circuit board such as a printed circuit board 210 on which a plurality of first light sources 221 and a plurality of second light sources 222 are mounted. The light source part 200 may include a plurality of light emitting blocks EL corresponding to the m*n display blocks DB. Each of the light emitting block EL includes the first light source 221 and the second light source 222. The luminances of the light emitting blocks EL are independently controlled so that the light emitting blocks EL are driven in a local dimming method. The light source part 200 may further include an optic element 230. The light source part 200 generates a light and provides the light to the display panel 100.

The first light source 221 generates a light having a mixed color of the first primary color, the second primary color and a third primary color. In the present exemplary embodiment, the first primary color is red, the second primary color is green, the third primary color is blue, and the mixed color of the first, second and third primary colors is white.

The second light source 222 generates a light having the third primary color.

When the first, second and third primary colors are mixed with one another, the mixed color is white. Although the first, second and third primary colors are respectively red, green and blue in the present exemplary embodiment, the present invention is not limited thereto.

In the present exemplary embodiment, the first light source 221 may be a light emitting diode (“LED”) chip which emits a white light. The second light source 222 may be a LED chip which emits a blue light.

For example, the optic element 230 may condense or diffuse light from the first and second light sources 221 and 222. The optic element 230 may improve an efficiency of the light from the first and second light sources 221 and 222, and may improve uniformity of the light irradiated onto a same display block DB.

Although the display apparatus is the liquid crystal display apparatus including the liquid crystal layer 130, the present invention is not limited thereto. Alternatively, the display apparatus may be organic light emitting diode (“OLED”) display apparatus including the OLEDs.

The local dimming driver 400 independently drives the light emitting blocks EL. The local dimming driver 400 may include a dimming level determining part and a light emitting driving part.

The dimming level determining part divides the input image data into a plurality of image blocks based on the light emitting blocks EL. The dimming level determining part determines a representative grayscale of the image block using a histogram of the grayscales of the input image data included in the image block. For example, the representative grayscale may be a maximum grayscale in the image block. Alternatively, the representative grayscale may be an average grayscale in the image block.

The dimming level determining part determines dimming levels of the light emitting blocks EL using the representative grayscales of the image blocks and generates the light source control signal including the dimming levels.

When the grayscale of the first primary color is A, the grayscale of the second primary color is B, the grayscale of the third primary color is C, the maximum grayscale of A, B and C in the image block is block_max(A, B, C), and the maximum grayscale of C in the image block is block_max(C), the dimming level is determined as follows.

The dimming level determining part may determine the dimming levels of the first light sources 221 as block_max(A, B, C) during the first subframe.

The dimming level determining part may determine the dimming levels of the second light sources 222 as block_max(C) during the second subframe.

The light emitting driving part generates a light source driving signals to drive the light emitting blocks EL based on the light source control signal generated by the dimming level determining part. The light source driving signal may be a pulse width modulation (“PWM”) signal. The dimming level may correspond to a duty ratio of the PWM signal.

The light emitting driving part may alternately turn on and off the first and second light sources 221 and 222. For example, during a first subframe, the first light source 221 is turned on and the second light source 222 is turned off. In contrast, during a second subframe, the first light source 221 is turned off and the second light source 222 is turned on.

Duration of the first subframe may be substantially equal to duration of the second frame. Alternatively, the duration of the first subframe may be different from the duration of the second frame.

For example, the display panel 100 may display the images in a frame rate of 120 Hz (hertz). The local dimming driver 400 may alternately turn on the first and second light sources 221 and 222 in a frequency of 120 Hz. Alternatively, the display panel 100 may display the images in a frame rate of 240 Hz. The local dimming driver 400 may alternately turn on the first and second light sources 221 and 222 in a frequency of 240 Hz. The display panel driver 300 operates subpixel rendering to set grayscale data of the first subpixel R, the second subpixel G and the transparent subpixel T.

Herein, A is a grayscale of the first primary color, B is a grayscale of the second primary color, C is a grayscale of the third primary color and min(A, B, C) is a minimum value of A, B and C. Hereinafter, a subpixel rendering method of the present exemplary embodiment is explained.

During the first subframe, when the first light source 221 is turned on, the display panel driver 300 may set the grayscale data of the first subpixel R to A-min(A, B, C), the grayscale data of the second subpixel G to B-min(A, B, C) and the grayscale data of the transparent subpixel T to min(A, B, C).

During the second subframe, when the second light source 222 is turned on, the display panel driver 300 may set the grayscale data of the transparent subpixel T to C-min(A, B, C).

According to the present exemplary embodiment, the display panel 100 includes red, green and transparent subpixels R, G and T. The light source part 200 including white and blue light sources WL and BL which are alternately turned on and off is driven in a local dimming method. Due to the local dimming method, an area displaying non-color image does not generate color breakup. Thus, a display quality of the display panel 100 may be improved.

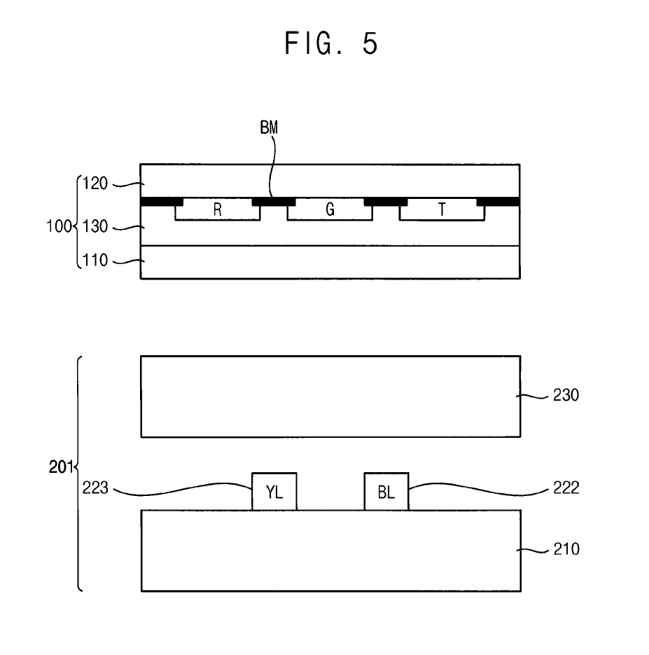

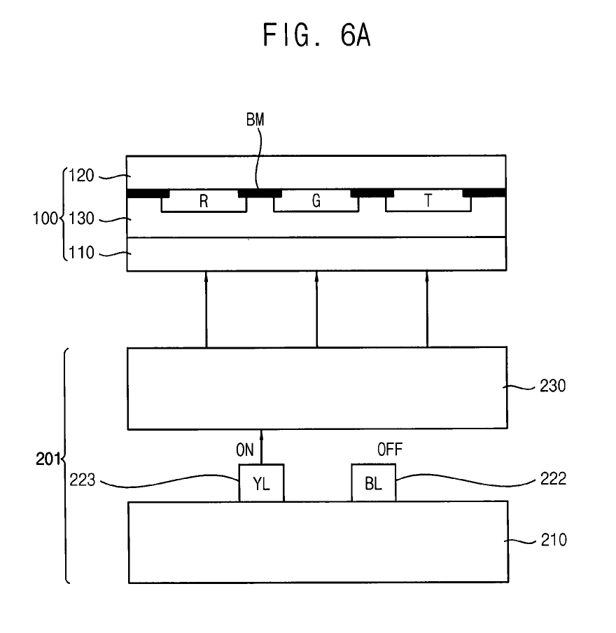

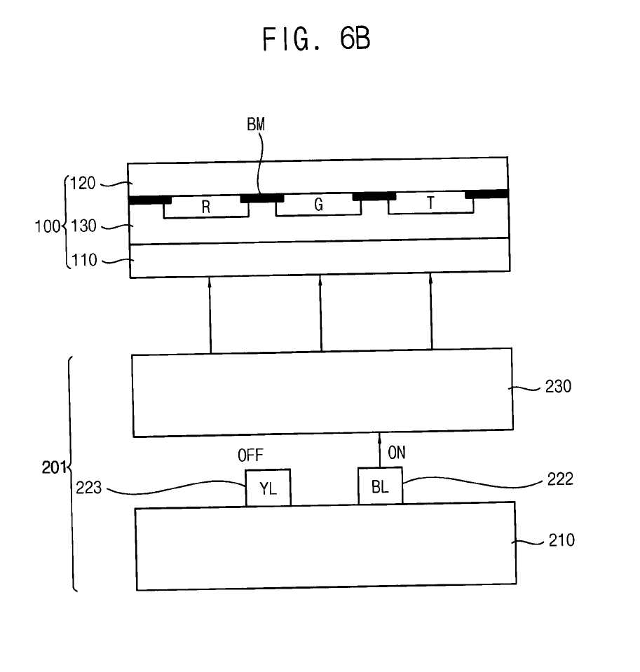

FIG. 5 is a cross-sectional view illustrating a display panel and a light source part according to an exemplary embodiment of the inventive concept. FIG. 6A is a cross-sectional view illustrating the display panel and the light source part of FIG. 5 in a first subframe. FIG. 6B is a cross-sectional view illustrating the display panel and the light source part of FIG. 5 in a second subframe.

The display apparatus according to the illustrated exemplary embodiment is substantially the same as the display apparatus in FIGS. 1 to 4B except that the first light source is a yellow light source. Thus, the same reference numerals will be used to refer to same or like parts as those described in with reference to FIGS. 1 to 4B and any further repetitive explanation concerning the above elements will be omitted.

Referring to FIGS. 1, 2, 5, 6A and 6B, the display apparatus includes a display panel 100, a light source part 201, a display panel driver 300 and a local dimming driver 400.

The display panel 100 displays an image. The display panel 100 includes a plurality of unit pixels, a first substrate 110, a second substrate 120 and a liquid crystal layer 130.

The unit pixel includes a first subpixel R having a first primary color, a second subpixel G having a second primary color and a transparent subpixel T.

In the present exemplary embodiment, the first primary color is red. The first subpixel R is a red subpixel. The second primary color is green. The second subpixel G is a green subpixel.

The first subpixel R may be defined by a red color filter disposed on the second substrate 120. The second subpixel G may be defined by a green color filter disposed on the second substrate 120. The transparent subpixel T may be defined by a transparent color filter disposed on the second substrate 120. For example, the transparent color filter may be a substantially empty space at which any color filter is not disposed. A light blocking pattern BM may be disposed between the color filters.

The display panel driver 300 is connected to the display panel 100 to drive the display panel 100. The display panel driver 300 may include a timing controller, a gate driver and a data driver.

The display panel driver 300 sets grayscale data of the first, second and transparent subpixels R, G and T.

The display panel driver 300 outputs the input image data and the third control signal to control a driving timing of the local dimming driver 400 to the local dimming driver 400. The display panel driver 300 may be synchronized with the local dimming driver 400.

The light source part 201 includes a circuit board such as printed circuit board 210 on which a plurality of first light sources 223 and a plurality of second light sources 222 are mounted. The light source part 201 may include a plurality of light emitting blocks EL corresponding to the m*n display blocks DB. Each of the light emitting block EL includes the first light source 223 and the second light source 222. The luminances of the light emitting blocks EL are independently controlled so that the light emitting blocks EL are driven in a local dimming method. The light source part 201 may further include an optic element 230. The light source part 201 generates a light and provides the light to the display panel 100.

The first light source 223 generates a light having a mixed color of the first primary color and the second primary color. In the present exemplary embodiment, the first primary color is red, the second primary color is green, a third primary color is blue and the mixed color of the first and second primary colors is yellow.

The second light source 222 generates a light having the third primary color.

When the first, second and third primary colors are mixed with one another, the mixed color is white. Although the first, second and third primary colors are respectively red, green and blue in the present exemplary embodiment, the present invention is not limited thereto.

In the present exemplary embodiment, the first light source 223 may be a LED chip which emits a yellow light. The second light source 222 may be a LED chip which emits a blue light.

In the present exemplary embodiment, the light source part 201 may be a direct type backlight assembly. Alternatively, the light source part 201 may be an edge type backlight assembly. When the light source part 201 is the edge type backlight assembly, the number of the local dimming blocks may decrease compared to the direct type backlight assembly.

Although the display apparatus is the liquid crystal display apparatus including the liquid crystal layer 130, the present invention is not limited thereto. Alternatively, the display apparatus may be organic light emitting diode (“OLED”) display apparatus including the OLEDs.

The local dimming driver 400 independently drives the light emitting blocks EL. The local dimming driver 400 may include a dimming level determining part and a light emitting driving part.

The dimming level determining part divides the input image data into a plurality of image blocks based on the light emitting blocks EL. The dimming level determining part determines a representative grayscale of the image block using a histogram of the grayscales of the input image data included in the image block. For example, the representative grayscale may be a maximum grayscale in the image block. Alternatively, the representative grayscale may be an average grayscale in the image block.

The dimming level determining part determines dimming levels of the light emitting blocks EL using the representative grayscales of the image blocks and generates the light source control signal including the dimming levels.

When the grayscale of the first primary color is A, the grayscale of the second primary color is B, the grayscale of the third primary color is C, the maximum grayscale of A, B and C in the image block is block_max(A, B, C), and the maximum grayscale of C in the image block is block_max(C), the dimming level is determined as follows.

The dimming level determining part may determine the dimming levels of the first light sources 223 as block_max(A, B, C) during the first subframe.

The dimming level determining part may determine the dimming levels of the second light sources 222 as block_max(C) during the second subframe.

The light emitting driving part generates a light source driving signals to drive the light emitting blocks EL based on the light source control signal. The light source driving signal may be a pulse width modulation (“PWM”) signal. The dimming level may correspond to a duty ratio of the PWM signal.

The light emitting driving part may alternately turn on and off the first and second light sources 223 and 222. For example, during a first subframe, the first light source 223 is turned on and the second light source 222 is turned off. In contrast, during a second subframe, the first light source 223 is turned off and the second light source 222 is turned on.

Duration of the first subframe may be substantially equal to duration of the second frame. Alternatively, the duration of the first subframe may be different from the duration of the second frame.

For example, the display panel 100 may display the images in a frame rate of 120 Hz (hertz). The local dimming driver 400 may alternately turn on the first and second light sources 223 and 222 in a frequency of 120 Hz. Alternatively, the display panel 100 may display the images in a frame rate of 240 Hz. The local dimming driver 400 may alternately turn on the first and second light sources 223 and 222 in a frequency of 240 Hz. The display panel driver 300 operates subpixel rendering to set grayscale data of the first subpixel R, the second subpixel G and the transparent subpixel T.

Herein, A is a grayscale of the first primary color, B is a grayscale of the second primary color, C is a grayscale of the third primary color and min(A, B) is a minimum value of A and B. Hereinafter, a subpixel rendering method of the present exemplary embodiment is explained.

During the first subframe, when the first light source 223 is turned on, the display panel driver 300 may set the grayscale data of the first subpixel R to A-min(A, B), the grayscale data of the second subpixel G to B-min(A, B) and the grayscale data of the transparent subpixel T to min(A, B).

During the second subframe, when the second light source 222 is turned on, the display panel driver 300 may set the grayscale data of the transparent subpixel T to C.

According to the present exemplary embodiment, the display panel 100 includes red, green and transparent subpixels R, G and T. The light source part 201 including yellow and blue light sources YL and BL which are alternately turned on and off is driven in a local dimming method. Due to the local dimming method, an area displaying non-color image does not generate color breakup. Thus, a display quality of the display panel 100 may be improved.

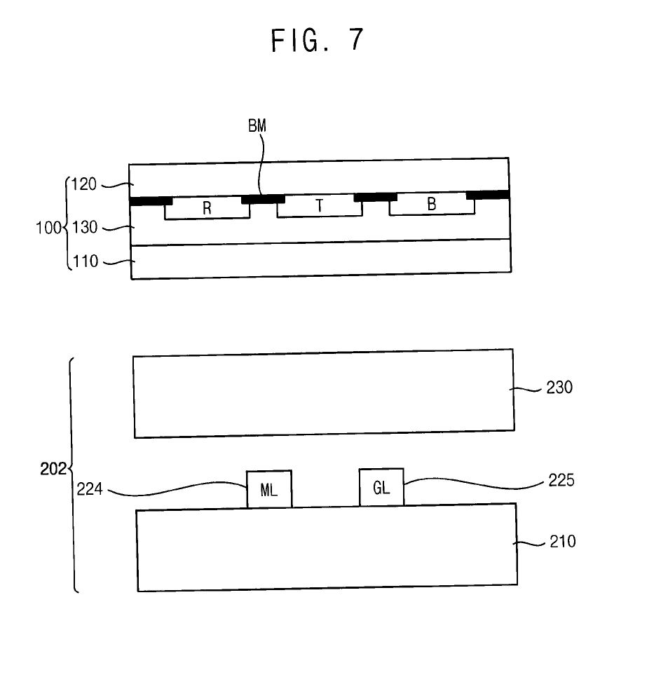

FIG. 7 is a cross-sectional view illustrating a display panel and a light source part according to an exemplary embodiment of the inventive concept.

The display apparatus according to the illustrated exemplary embodiment is substantially the same as the display apparatus in FIGS. 5 to 6B except that the first subpixel is a red subpixel, the second subpixel is a blue subpixel, the first light source is a magenta light source and the second light source is a green light source. Thus, the same reference numerals will be used to refer to same or like parts as those described in with reference to FIGS. 5 to 6B and any further repetitive explanation concerning the above elements will be omitted.

Referring to FIGS. 1, 2 and 7, the display apparatus includes a display panel 100, a light source part 202, a display panel driver 300 and a local dimming driver 400.

The display panel 100 displays an image. The display panel 100 includes a plurality of unit pixels, a first substrate 110, a second substrate 120 and a liquid crystal layer 130.

The unit pixel includes a first subpixel R having a first primary color, a second subpixel B having a second primary color and a transparent subpixel T.

In the present exemplary embodiment, the first primary color is red. The first subpixel R is a red subpixel. The second primary color is blue. The second subpixel B is a blue subpixel.

The first subpixel R may be defined by a red color filter disposed on the second substrate 120. The second subpixel B may be defined by a blue color filter disposed on the second substrate 120. The transparent subpixel T may be defined by a transparent color filter disposed on the second substrate 120. For example, the transparent color filter may be a substantially empty space at which any color filter is not disposed. A light blocking pattern BM may be disposed between the color filters.

The display panel driver 300 sets grayscale data of the first, second and transparent subpixels R, B and T.

The light source part 202 includes a circuit board such as a printed circuit board 210 on which a plurality of first light sources 224 and a plurality of second light sources 225 are mounted. The light source part 202 may include a plurality of light emitting blocks EL corresponding to the m*n display blocks DB. Each of the light emitting block EL includes the first light source 224 and the second light source 225. The luminances of the light emitting blocks EL are independently controlled so that the light emitting blocks EL are driven in a local dimming method. The light source part 202 may further include an optic element 230. The light source part 202 generates a light and provides the light to the display panel 100.

The first light source 224 generates a light having a mixed color of the first primary color and the second primary color. In the present exemplary embodiment, the first primary color is red, the second primary color is blue, a third primary color is green and the mixed color of the first and second primary colors is magenta.

The second light source 225 generates a light having the third primary color.

The local dimming driver 400 independently drives the light emitting blocks EL. The local dimming driver 400 may include a dimming level determining part and a light emitting driving part.

According to the present exemplary embodiment, the display panel 100 includes red, blue and transparent subpixels R, B and T. The light source part 202 including magenta and green light sources ML and GL which are alternately turned on and off is driven in a local dimming method. Due to the local dimming method, an area displaying non-color image does not generate color breakup. Thus, a display quality of the display panel 100 may be improved.

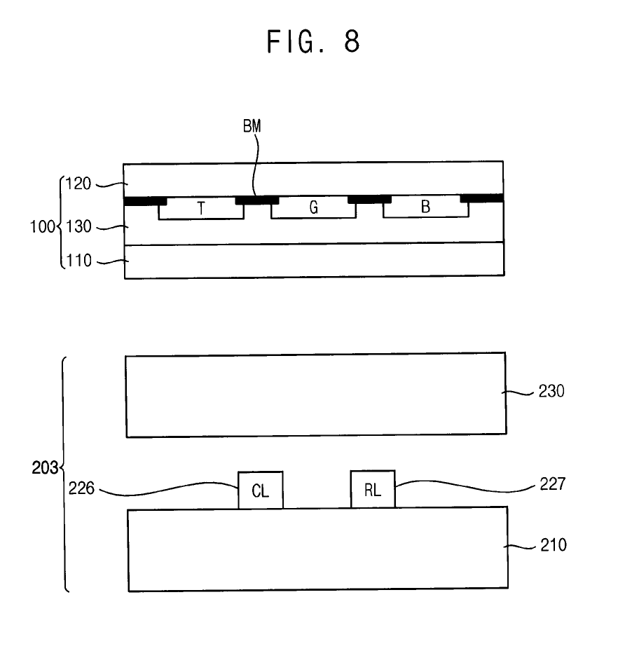

FIG. 8 is a cross-sectional view illustrating a display panel and a light source part according to an exemplary embodiment of the inventive concept.

The display apparatus according to the illustrated exemplary embodiment is substantially the same as the display apparatus in FIGS. 5 to 6B except that the first subpixel is a green subpixel, the second subpixel is a blue subpixel, the first light source is a cyan light source and the second light source is a red light source. Thus, the same reference numerals will be used to refer to same or like parts as those described in with reference to FIGS. 5 to 6B and any further repetitive explanation concerning the above elements will be omitted.

Referring to FIGS. 1, 2 and 8, the display apparatus includes a display panel 100, a light source part 203, a display panel driver 300 and a local dimming driver 400.

The display panel 100 displays an image. The display panel 100 includes a plurality of unit pixels, a first substrate 110, a second substrate 120 and a liquid crystal layer 130.

The unit pixel includes a first subpixel G having a first primary color, a second subpixel B having a second primary color and a transparent subpixel T.

In the present exemplary embodiment, the first primary color is green. The first subpixel G is a green subpixel. The second primary color is blue. The second subpixel B is a blue subpixel.

The first subpixel G may be defined by a green color filter disposed on the second substrate 120. The second subpixel B may be defined by a blue color filter disposed on the second substrate 120. The transparent subpixel T may be defined by a transparent color filter disposed on the second substrate 120. For example, the transparent color filter may be a substantially empty space at which any color filter is not disposed. A light blocking pattern BM may be disposed between the color filters.

The display panel driver 300 sets grayscale data of the first, second and transparent subpixels G, B and T.

The light source part 203 includes a circuit board such as a printed circuit board 210 on which a plurality of first light sources 226 and a plurality of second light sources 227 are mounted. The light source part 203 may include a plurality of light emitting blocks EL corresponding to the m*n display blocks DB. Each of the light emitting block EL includes the first light source 226 and the second light source 227. The luminances of the light emitting blocks EL are independently controlled so that the light emitting blocks EL are driven in a local dimming method. The light source part 203 may further include an optic element 230. The light source part 203 generates a light and provides the light to the display panel 100.

The first light source 226 generates a light having a mixed color of the first primary color and the second primary color. In the present exemplary embodiment, the first primary color is green, the second primary color is blue, a third primary color is red and the mixed color of the first and second primary colors is cyan.

The second light source 227 generates a light having the third primary color.

The local dimming driver 400 independently drives the light emitting blocks EL. The local dimming driver 400 may include a dimming level determining part and a light emitting driving part.

According to the present exemplary embodiment, the display panel 100 includes red, blue and transparent subpixels G, B and T. The light source part 203 including magenta and red light sources CL and RL which are alternately turned on and off is driven in a local dimming method. Due to the local dimming method, an area displaying non-color image does not generate color breakup. Thus, a display quality of the display panel 100 may be improved.

According to the present invention as explained above, the display panel includes subpixels having some of primary colors and a transparent subpixel. The light source part is driven in a local dimming method and the light source part includes light sources having different colors which are alternately turned on. Thus, a color breakup may decrease so that a display quality of the display panel may be improved.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the inventive concept. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A display apparatus comprising:
a display panel comprising:
a first subpixel having a first primary color;
a second subpixel having a second primary color; and
a transparent subpixel;
a display panel driver configured to set grayscales of the first subpixel, the second subpixel, and the transparent subpixel;
a light source part comprising a plurality of light emitting blocks configured to provide light to the display panel, each light emitting block comprising a first light source configured to generate a light of a mixed color and a second light source configured to generate a light of a third primary color; and
a local dimming driver configured to alternately turn on and off the first light source and the second light source and configured to independently drive the plurality of light emitting blocks.

2. The display apparatus of claim 1, wherein the local dimming driver is configured to determine first dimming levels of the first light sources as block_max(A, B, C) during a first subframe when the first light sources are turned on and to determine second dimming levels of the second light sources as block_max(C) during a second subframe when the second light sources are turned on, and
wherein a grayscale of the first primary color is A, a grayscale of the second primary color is B, a grayscale of the third primary color is C, a maximum grayscale of A, B and C in an image block corresponding to the light emitting block is block_max(A, B, C), and a maximum grayscale of C in the image block is block_max(C).

3. The display apparatus of claim 2, wherein the display panel driver is configured to set the grayscale of the first subpixel to A-min(A, B, C), the grayscale of the second subpixel to B-min(A, B, C), and the grayscale of the transparent subpixel to min(A, B, C) during the first subframe,
wherein the display panel driver is configured to set the grayscale of the transparent subpixel to C-min(A, B, C) during the second subframe, and
wherein min(A, B, C) is a minimum grayscale of A, B and C.

4. The display apparatus of claim 3, wherein the mixed color is white, and
wherein the third primary color is blue.

5. The display apparatus of claim 2, wherein the display panel driver is configured to set the grayscale of the first subpixel to A-min(A, B), the grayscale of the second subpixel to B-min(A, B), and the grayscale of the transparent subpixel to min(A, B) during the first subframe,
wherein the display panel driver is configured to set the grayscale of the transparent subpixel to C during the second subframe, and
wherein min(A, B) is a minimum grayscale of A and B.

6. The display apparatus of claim 5, wherein the mixed color is yellow, and
wherein the third primary color is blue.

7. The display apparatus of claim 5, wherein the mixed color is magenta, and
wherein the third primary color is green.

8. The display apparatus of claim 5, wherein the mixed color is cyan, and
wherein the third primary color is red.

9. The display apparatus of claim 1, wherein the display panel driver is synchronized with the local dimming driver.

10. The display apparatus of claim 1, wherein the first primary color is red, and
wherein the second primary color is green.

11. A method of driving a display apparatus, the method comprising:
setting grayscales of a first subpixel having a first primary color, a second subpixel having a second primary color, and a transparent subpixel;
determining a plurality of first dimming levels and a plurality of second dimming levels of a plurality of light emitting blocks;
turning on the light emitting blocks based on the first dimming levels during a first subframe; and
turning on the light emitting blocks based on the second dimming levels during a second subframe.

12. The method of claim 11, wherein the first dimming level is determined as block_max(A, B, C) and the second dimming level is determined as block_max(C), and
wherein a grayscale of the first primary color is A, a grayscale of the second primary color is B, a grayscale of the third primary color is C, a maximum grayscale of A, B and C in an image block corresponding to the light emitting block is block_max(A, B, C), and a maximum grayscale of C in the image block is block_max(C).

13. The method of claim 12, wherein the grayscale of the first subpixel is set to A-min(A, B, C), the grayscale of the second subpixel is set to B-min(A, B, C) and the grayscale of the transparent subpixel is set to min(A, B, C) during the first subframe, and
wherein the grayscale of the transparent subpixel is set to C-min(A, B, C) during the second subframe, and
wherein min(A, B, C) is a minimum grayscale of A, B and C.

14. The method of claim 13, wherein the mixed color is white, and
wherein the third primary color is blue.

15. The method of claim 12, wherein the grayscale of the first subpixel is set to A-min(A, B), the grayscale of the second subpixel is set to B-min(A, B), and the grayscale of the transparent subpixel is set to min(A, B) during the first subframe,
wherein the grayscale of the transparent subpixel is set to C during the second subframe, and
wherein min(A, B) is a minimum grayscale of A and B.

16. The method of claim 15, wherein the first light source is configured to generate a yellow light, and
wherein the second light is configured to generate a blue light.

17. The method of claim 15, wherein the first light source is configured to generate a magenta light, and
wherein the second light is configured to generate a green light.

18. The method of claim 15, wherein the first light source is configured to generate a cyan light, and
wherein the second light is configured to generate a red light.
